(19) United States
(12) Patent Application Publication
(10) Pub. No.: US 2025/0115160 A1
(43) Pub. Date: Apr. 10, 2025

(54) METHOD OF GUIDING DRIVEABLE DISTANCE OF ELECTRIC VEHICLE AND METHOD THEREOF

(71) Applicants: HYUNDAI MOTOR COMPANY, Seoul (KR); KIA CORPORATION, Seoul (KR)

(72) Inventor: Dong Il YANG, Hwaseong-si (KR)

(21) Appl. No.: 18/910,678

(22) Filed: Oct. 9, 2024

(30) Foreign Application Priority Data
Oct. 10, 2023 (KR) 10-2023-0134287

(51) Int. Cl. B60L 58/12; B60L 1/00; B60L 15/20; B60L 58/26; B60L 58/27

(52) U.S. Cl. CPC B60L 58/12; B60L 1/003; B60L 15/20; B60L 58/26; B60L 58/27; B60L 2240/642; B60L 2250/16

(57) ABSTRACT

A drivable distance guiding method of an electric vehicle can include collecting information of factors affecting a drivable distance; collecting current state information of each of the factors; and calculating a factor affecting the drivable distance based on the current state information of each of the factors.

### CROSS-REFERENCE TO RELATED APPLICATIONS

This application claims the benefit of Korean Patent Application No. 10-2023-0134287, filed on Oct. 10, 2023, which is hereby incorporated by reference as if fully set forth herein.

### TECHNICAL FIELD

The present disclosure relates to a method and system for guiding a drivable distance of an electric vehicle.

### BACKGROUND

An electric vehicle operates by charging its battery with electric power and using that stored power to drive the motor. Since the distance an electric vehicle can travel is limited by the battery's capacity, it is necessary to inform the driver of the vehicle's potential travel distance with the remaining battery charge. To address this, the electric vehicle provides a function that estimates the remaining distance the vehicle can travel, commonly referred to as distance to empty (DTE), based on the currently available battery energy and displays this information on the vehicle's dashboard.

In addition to powering the motor, the battery is also used to operate auxiliary systems such as cameras, lights, and the air conditioning system. As a result, even for the same route, the battery consumption can vary depending on factors like road gradients or additional system usage. Therefore, the available battery energy may fluctuate, leading to frequent changes in the estimated DTE.

However, conventional DTE display methods only show a numeric value for the remaining travel distance, which may not effectively convey to the driver the reasons for sudden changes in the DTE while driving.

### SUMMARY

The present disclosure is directed to a method and a system for providing a drivable distance of an electric vehicle, helping a driver to understand a reason behind changes in the estimated remaining drivable distance.

According to one aspect of the present disclosure, a drivable distance guiding method of an electric vehicle can include collecting information of factors related to a drivable distance, collecting current state information of each of the factors, and calculating factors related to the drivable distance based on the current state information of each of the factors.

According to another aspect of the present disclosure, a drivable distance guiding system of an electric vehicle can include a battery management unit configured to provide information related to a remaining power amount of a battery of the electric vehicle, at least two device units using power of the battery, and a control unit configured to calculate and display a drivable distance based on the information related to the remaining power amount of the battery, collect current state information of factors related to the drivable distance among functions performed by the at least two device units, and calculate a factor related to the drivable distance based on the current state information of each of the factors.

In some implementations, the drivable distance guiding method and system of an electric vehicle can display information about factors that affect a drivable distance of the electric vehicle to assist a customer in understanding a reason for a change in the drivable distance.

According to another aspect of the present disclosure, the drivable distance guiding method and system of an electric vehicle can display a factor that is excessively affecting a distance to empty (DTE) and display a DTE extendable by changing the settings of each factor, thereby efficiently managing a battery of the electric vehicle.

### BRIEF DESCRIPTION OF THE DRAWINGS

FIG. 1 is a diagram illustrating an example of a drivable distance guiding system of an electric vehicle.

FIG. 2 is a diagram illustrating an example of a distance to empty (DTE) manager of FIG. 1.

FIG. 3 is a diagram illustrating an exemplary screen showing DTE influence information.

FIG. 4 is a diagram illustrating an exemplary screen showing DTE influence information.

FIG. 5 is a flowchart illustrating an example of a drivable distance guiding method of an electric vehicle.

FIG. 6 is a diagram illustrating an exemplary screen showing DTE influence information.

### DETAILED DESCRIPTION

In the present disclosure, displaying factors that may affect a drivable distance (or a “distance to empty (DTE)”) and the degree of influence of each factor can assist the driver in understanding the reasons for changes in the DTE. Additionally, displaying a factor that is significantly impacting the DTE and displaying how the DTE could be extended by adjusting certain settings may encourage efficient battery management.

Hereinafter, a method and system for guiding a drivable distance (or DTE) of an electric vehicle will be described with reference to the accompanying drawings. The method and system for guiding a drivable distance (or DTE) will be referred to as a drivable distance guiding method and system for simplicity.

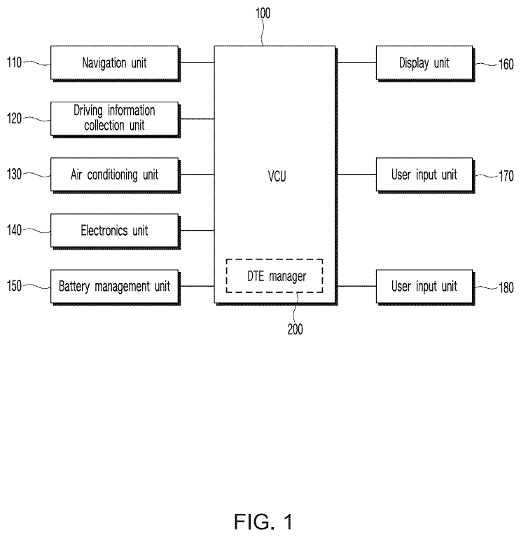

FIG. 1 is a diagram illustrating an example of a drivable distance guiding system of an electric vehicle.

Referring to FIG. 1, a drivable distance guiding system of an electric vehicle can include a navigation unit 110, a driving information collection unit 120, an air conditioning unit 130, an electronics unit 140, a battery management unit 150, a display unit 160, a user input unit 170, a memory 180, and a vehicle control unit (VCU) 100 including a DTE manager 200.

The navigation unit 110 can receive current location information and traffic information from an external device such as a global positioning system (GPS) satellite, a navigation server, and the like, and can generate navigation information. For example, the navigation unit can generate the navigation information by setting a path to a destination set by a driver. The navigation unit 110 can also generate and manage driving pattern information based on a revolutions per minute (RPM), a daily driving range, a driving speed, sudden braking, sudden start, and the like, which are intermittently detected while driving.

In some implementations, the navigation unit 110 can generate driving information including information about a road on which the electric vehicle is traveling. The driving information, which is information collected based on a current location of the vehicle, can include gradient information of a current road, gradient information of an upcoming road, and remaining distance information about a remaining distance to the upcoming road. The navigation unit 110 can provide, to the VCU 100, a path according to a destination, driving information including gradient information of a current road and an upcoming road, and the like, as DTE management-related information.

The driving information collection unit 120 can include an accelerator pedal position sensor (APS) and a brake pedal position sensor (BPS) respectively configured to detect an accelerator pedal operation and a brake pedal operation performed by the driver, and a speed detection unit configured to detect a current speed of the vehicle. The driving information collection unit 120 can receive an APS signal, a BPS signal, and a vehicle speed signal to calculate an average speed of the vehicle. The driving information collection unit 120 can provide, to the VCU 100, the current speed of the vehicle, the average speed of the vehicle, and the like, as the DTE management-related information.

In some implementations, the air conditioning unit 130 can adjust the indoor temperature of the vehicle based on input received from a user. The air conditioning unit 130 can include a cooling device (e.g., an air conditioning compressor) and a heating device (e.g., an electric heater), as an air conditioning device configured to adjust the indoor temperature. The air conditioning unit 130 can provide, to the VCU 100, on/off information of the air conditioning device as the DTE management-related information, and can calculate and provide power consumed by the air conditioning device.

The electronics unit 140 can include devices (e.g., an audio, video, navigation (AVN) system, a vehicle lighting device, a black box (e.g., a dash camera), a sensor, a cell phone charger, etc.) that interact with an electronic control unit (ECU) in the vehicle or use a battery in the vehicle through a vehicle network. The electronics unit 140 can provide, to the VCU 100, on/off information of the devices (also “electronic devices” herein) as the DTE management-related information.

The battery management unit 150 can obtain battery state information such as a battery temperature and a state of charge (SOC), and can perform battery charging and discharging control based on the collected battery state information. In some implementations, the battery management unit 150 can monitor a battery temperature, an ambient temperature, an SOC, and the like to perform battery conditioning. During battery conditioning, the battery management unit 150 can activate a battery heater or activate a cooling system such as a battery chiller to control the temperature of the battery to be within a preset range. The battery management unit 150 can obtain, in real time, the battery state information as the DTE management-related information and can provide, to the VCU 100, the obtained real-time information along with battery conditioning information.

The display unit 160 can include a multimedia device such as an AVN system, a cluster, and the like. The display unit 160 can display DTE information, and can also display factors impacting a DTE and an influence of each factor, under the control of the VCU 100. The display unit 160 can also provide, to a user, a factor significantly impacting the DTE, and can display a DTE, which is estimated when the settings of the factor impacting the DTE are changed.

The user input unit 170 can be a button provided on the AVN system or a touchscreen implemented on a display. The user can select various functions by operating the user input unit 170. For example, the user can input a destination, set the indoor temperature, or turn on/off functions of the electronic devices through the user input unit 170. The user input unit 170 can also offer an option for the user to select an automatic DTE management mode.

The memory 180 can store various setting information for the control by the VCU 100, audio information, video information, program information, and the like.

The VCU 100 can control the overall function of the vehicle by controlling the navigation unit 110, the driving information collection unit 120, the air conditioning unit 130, the electronics unit 140, the battery management unit 150, the display unit 160, the user input unit 170, and the memory 180.

In some implementations, the VCU 100 can include the DTE manager 200 configured to calculate and display a DTE according to a remaining power amount of the battery, calculate influences of factors impacting the DTE, and display the calculated influences on the display unit 160. The VCU 100 can calculate a DTE that can be secured by changing the settings of each factor, and can display such improvable DTE information on the display unit 160.

In some implementations, when the automatic DTE management mode is selected through the user input unit 170, the VCU 100 can change the settings of each factor to maximize the DTE.

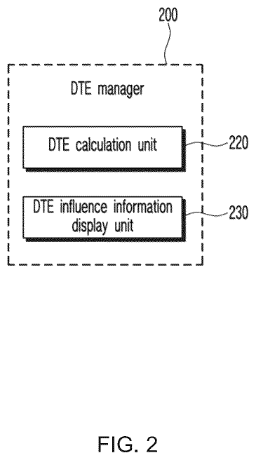

FIG. 2 is a diagram illustrating an example of the DTE manager 200 of FIG. 1.

Referring to FIG. 2, the DTE manager 200 can include a DTE calculation unit 220 and a DTE influence information display unit 230. The VCU 100, the DTE manager 200, the DTE calculation unit 220, and the DTE influence information display unit 230 illustrated in FIGS. 1 and 2 can be control elements that perform cooperative control to calculate a DTE and an influence of each factor impacting the DTE. In some implementations, the DTE calculation unit 220 and the DTE influence information display unit 230 can be merged or divided, and a drivable distance guiding method (also a DTE guiding method) can be performed by the VCU 100, or some or all of the functions thereof can be provided by a separate control module.

The DTE calculation unit 220 can calculate a DTE based on a current vehicle speed provided by the driving information collection unit 120 and battery remaining amount information provided by the battery management unit 150. In some implementations, when a driving pattern of the driver is stored in the driving information collection unit 120, the DTE calculation unit 220 can apply the driving pattern to correct the DTE, and can also apply real-time traffic information to correct the DTE. Further, the DTE calculation unit 220 can estimate and calculate a DTE based on a change in factors impacting the DTE. For example, the DTE calculation unit 210 can calculate a DTE value, which is estimated when a factor causing a decrease in the DTE is eliminated.

The DTE influence information display unit 230 can display information of factors impacting a DTE. A factor impacting a DTE can refer to a device or environment that consumes a great amount of battery power and can be selected from among, for example, an average vehicle speed, whether an air conditioning device is activated, the magnitude of gradient, whether an electronic device is activated, whether battery conditioning is performed, and the like.

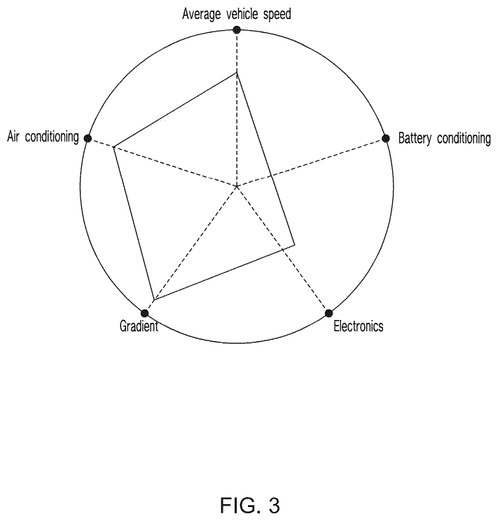

A method performed by the DTE influence information display unit 230 to display information of factors impacting a DTE will be described in more detail with reference to FIG. 3.

FIG. 3 is a diagram illustrating an exemplary screen showing DTE influence information, which displays a DTE influence based on average speed, air conditioning, gradient, electronics (or electronic devices herein), and battery conditioning.

The DTE influence information display unit 230 can set maximum (max) and minimum (min) values for each factor to display their respective influences. For example, a minimum value and a maximum value of an average vehicle speed can be set to 0 kilometers per hour (kph) and 180 kph, respectively. A minimum value of an air conditioning device can be set to 0 watts (W), which is a state where the air conditioning device is in an off state, and a maximum value thereof can be set to 3000 W, which is a state where the air conditioning device consumes maximum power. A minimum value and a maximum value of a gradient of a road on which the vehicle is traveling can be set to −40° and +40°, respectively. A minimum value of power consumption of an electronic device can be set to 0 W, which is a state where the electronic device is in an off state, and a maximum value thereof can be set to 1000 W, which is a state where the electronic device consumes maximum power. A minimum value of power consumption by battery conditioning can be set to 0 W, and a maximum value thereof can be set to 4000 W.

The DTE influence information display unit 230 can display a DTE influence by displaying a currently obtained value of each factor, within a range of a maximum value (max) and a minimum value (min) of each factor. In some implementations, a frequency of displaying the influence can be set differently for each factor. For example, an influence of the average vehicle speed can be calculated and displayed every 10 minutes. An influence of the air conditioning device can be displayed in real time by estimating the power consumption of the air conditioning device. In addition, respective influences of the gradient, the electronic device, and the battery conditioning can be displayed in real time.

The DTE influence information display unit 230 can display the average vehicle speed obtained through the driving information collection unit 120 every 10 minutes. The DTE influence information display unit 230 can display the average vehicle speed in a range from 0 kph to 180 kph to display the influence by the average vehicle speed. In addition, the DTE influence information display unit 230 can display the power consumption of the air conditioning unit 130 calculated according to the on/off information of the air conditioning device provided by the air conditioning unit 130 in real time. In some implementations, the power consumption of the air conditioning unit 130 can be provided by the air conditioning unit 130 or can be calculated and provided by the VCU 100. The DTE influence information display unit 230 can display the current power consumption of the air conditioning unit 130, in a range from 0 W to 1000 W, to display an influence by the usage of an air conditioning function.

The DTE influence information display unit 230 can display a gradient of a road on which the vehicle is traveling, in a range from −40° to +40°, based on the driving information provided by the navigation unit 110, and can thereby display an influence by the gradient.

The DTE influence information display unit 230 can display the power consumption of the vehicle electronic device provided by the electronics unit 140, in a range from 0 W to 1000 W, to display an influence by the usage of the vehicle electronic device in real time. In some implementations, the power consumption of the electronics unit 140 can be provided by the electronics unit 140 or can be calculated and provided by the VCU 100.

The DTE influence information display unit 230 can display the power consumption due to battery conditioning provided by the battery management unit 150, in a range from 0 W to 4000 W, to display an influence by battery conditioning in real time. For example, the power consumption due to battery conditioning can be provided by the battery management unit 150 or can be calculated and provided by the VCU 100. By displaying the values of the factors in real time on a single graph as shown in FIG. 3, the influences of respective factors can be recognized all at once.

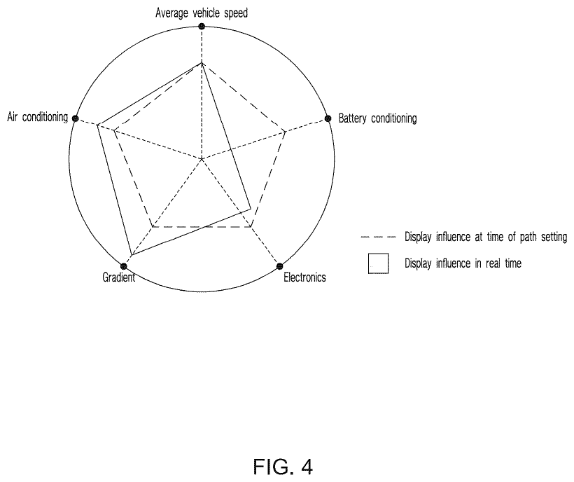

FIG. 4 is a diagram illustrating an exemplary screen showing DTE influence information.

Referring to FIG. 4, the DTE influence information display unit 230 can display a real-time influence X of each factor, along with an initial influence Y obtained at a time of path setting.

The DTE influence information display unit 230 can store, in a memory such as a buffer, the initial influence Y obtained at the time of path setting, and display both the real-time influence X of each factor and the initial influence Y obtained at the time of path setting. For example, in a case where a destination is a charging station, the DTE influence information display unit 230 can display the power consumption according to scheduled battery conditioning.

The DTE influence information display unit 230 can maintain a state in which both the initial influence Y and the real-time influence X are displayed together or can display them upon an occurrence of a preset event. For example, the DTE influence information display unit 230 can periodically display the initial influence Y, or display the initial influence Y together with the real-time influence X when a sum of influences of one or more factors or all the factors changes beyond a reference point.

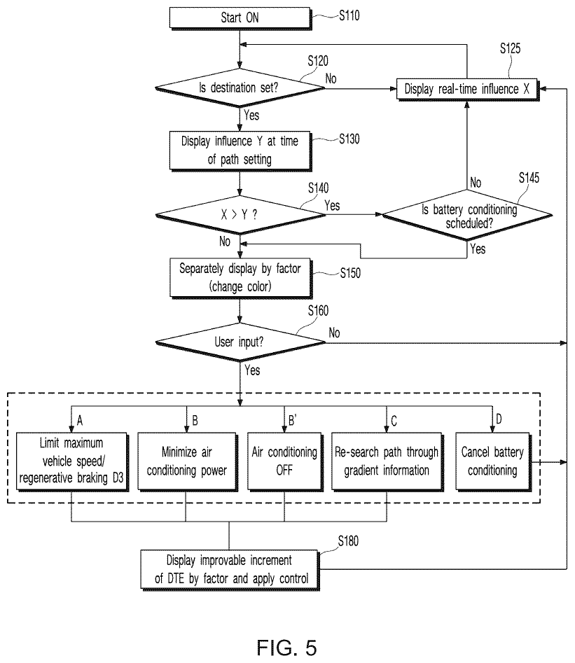

FIG. 5 is a flowchart illustrating an example of a drivable distance guiding method of an electric vehicle.

In step S120, when the vehicle ignition is started in step S110, the VCU 100 can determine whether a destination has been set by a user through the user input unit 170.

In step S125, based on a determination that the destination has not been set, the DTE influence information display unit 230 can display a real-time influence X of each factor on a DTE influence information screen. The VCU 100 can receive information of factors impacting a DTE from the navigation unit 110, the driving information collection unit 120, the air conditioning unit 130, the electronics unit 140, and the battery management unit 150. The information received by the VCU 100 can be processed by the DTE influence information display unit 230 of the DTE manager 200 and displayed on the DTE influence information screen.

In step S130, based on a determination that the destination has been set, the DTE influence information display unit 230 can display an initial influence Y at a time of path setting on the DTE influence information screen. The DTE influence information display unit 230 can display, as the initial influence Y, an influence of each factor received at the time of path setting. The DTE influence information display unit 230 can store the initial influence Y in a memory such as a buffer.

After the initial influence Y is displayed, the information of the factors impacting the DTE can be received in real time to determine whether the real-time influence X exceeds the initial influence Y (i.e., X>Y) in step S140.

Based on a determination that the real-time influence X exceeds the initial influence Y, whether battery conditioning is scheduled can be determined in step S145.

When the real-time influence X exceeds the initial influence Y, and the battery conditioning is not scheduled, the DTE influence information display unit 230 can display the real-time influence X of each factor on the DTE influence information screen in step S125.

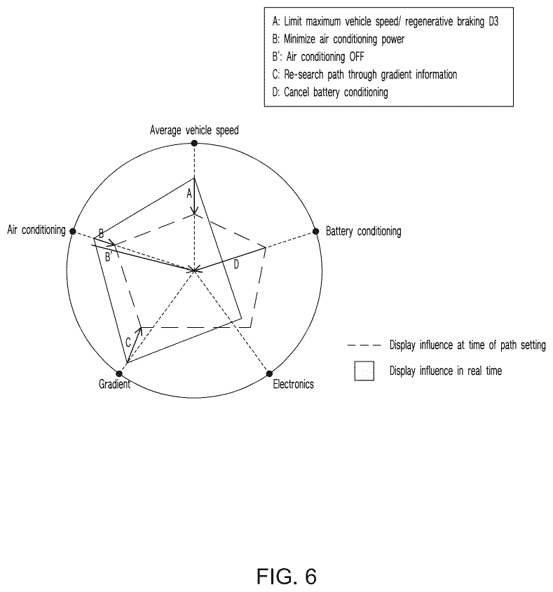

When the real-time influence X exceeds the initial influence Y, but the battery conditioning is scheduled, or when the real-time influence X does not exceed the initial influence Y, the DTE influence information display unit 230 can separately display a factor with an excessive real-time influence X among the factors in step S150. In this case, the screen can be displayed as shown in FIG. 6.

FIG. 6 is a diagram illustrating an exemplary screen showing DTE influence information. Referring to FIG. 6, the DTE influence information display unit 230 can display a factor with an excessive real-time influence X, e.g., an average vehicle speed, air conditioning, and gradient, among the factors, in a different color or in a box, to inform the user of this. In addition, when the factor with the excessive real-time influence X is changed in a direction indicated by an arrow, the DTE influence information display unit 230 can display a DTE that can be improved to guide the user to select an automatic control function for the factors impacting the DTE.

Referring back to FIG. 5, the VCU 100 can verify an input from the user input unit 170 in step S160.

When there is no user input, the DTE influence information display unit 230 can return to step S125 to display the real-time influence X and repeat the control process described above.

Based on a determination that there is a user input, the DTE influence information display unit 230 can change the settings of each factor in step S170 based on a function selected by the user, and display an available increment of the DTE improved by adjusting the corresponding factor in step S180.

In step S170, the user can select an automatic DTE management mode through the user input unit 170 or adjust the function of the factor impacting the DTE. For example, based on the user's selection, the VCU 100 can limit a maximum vehicle speed or perform regenerative braking (A) to reduce an influence of an average vehicle speed. The VCU 100 can minimize the power consumption of the air conditioning unit 130 (B) or turn off the air conditioning unit 130 (B′) to reduce an influence of the usage of an air conditioning device. The VCU 100 can control the navigation unit 110 to re-search for a path that can reduce gradient information (C) to reduce an influence of a gradient. The VCU 100 can control the battery management unit 150 to cancel battery conditioning (D) to reduce an influence of the battery conditioning. After canceling the battery conditioning, the VCU 100 can return to step S125 to display the real-time influence X and repeat the control process.

As described above, after changing the settings of each factor and displaying the available increment of the DTE improved by adjusting a corresponding factor, the process can return to step S125 to display the real-time influence X and repeat the control process.

According to implementations of these features, displaying information about factors that impact a drivable distance (also, a DTE herein) of an electric vehicle can assist a user in understanding a reason for a change in the drivable distance.

According to implementations of these features, a drivable distance guiding method and system can display a factor that is significantly impacting a DTE and display a DTE that is extendable when the settings of each factor are changed, thereby enabling efficient battery management.

The method of the implementations of the present disclosure described herein can be implemented as computer-readable code on a medium in which a program is recorded. The code and code segments including the program can be readily inferred by computer programmers having skill in the art. The written program can be stored on a computer-readable recording medium (or an information storage medium) and can be read and executed by a computer to implement the method of the implementations of the present disclosure. The recording medium can include any form of computer-readable recording medium.

What is claimed is:

1. A drivable distance guiding method of an electric vehicle, comprising:
obtaining information of one or more factors related to a drivable distance;
obtaining current state information of each of the one or more factors; and
calculating an influence degree of each of the one or more factors related to the drivable distance based on the current state information of each of the one or more factors.

2. The drivable distance guiding method of claim 1, further comprising:
displaying the influence degrees of the one or more factors related to the drivable distance.

3. The drivable distance guiding method of claim 1, wherein obtaining the information of the one or more factors comprises:
obtaining information of at least two factors with highest power usage among functions utilizing remaining battery power of the electric vehicle.

4. The drivable distance guiding method of claim 1, wherein obtaining the information of the one or more factors comprises:
obtaining information of at least two of an average vehicle speed factor, an air conditioning factor related to power consumption of an air conditioning device, a gradient factor related to a gradient of a road on which the electric vehicle is traveling, or a battery conditioning factor related to power consumption for battery conditioning.

5. The drivable distance guiding method of claim 2, wherein displaying the influence degrees of the one or more factors comprises:
setting a maximum value and a minimum value for each of the one or more factors; and
displaying current state information or a calculated influence degree for each of the one or more factors, in a range between the maximum value and the minimum value.

6. The drivable distance guiding method of claim 2, wherein displaying of the influence degrees of the one or more factors comprises:
displaying, based on a determination a destination has been set, an initial influence degree of each of the one or more factors according to the current state information of each of the one or more factors; and
displaying a real-time influence degree of each of the one or more factors based on the current state information of each of the one or more factors, while the vehicle is traveling.

7. The drivable distance guiding method of claim 6, further comprising:
based on the real-time influence degree of a factor exceeding a specified reference compared to the initial influence degree of the factor, displaying an instruction to adjust the factor;
adjusting a function of the factor selected by a user; and
displaying a drivable distance changed by the adjustment of the factor.

8. The drivable distance guiding method of claim 7, wherein adjusting the function of the factor comprises:
based on an automatic control function being selected, adjusting each of the one or more factors to maximize the drivable distance.

9. The drivable distance guiding method of claim 8, wherein adjusting each of the one or more factors to maximize the drivable distance comprises limiting a maximum vehicle speed to adjust an average vehicle speed factor, turning off an air conditioning device to adjust an air conditioning factor, re-searching for a path including a road of a preset gradient to adjust a gradient factor, or canceling a battery conditioning function to adjust a battery conditioning factor.

10. A drivable distance guiding system of an electric vehicle, comprising:
a battery management unit, implemented using one or more computing devices, configured to provide information related to a remaining power amount of a battery of the electric vehicle;
at least two device units using power of the battery; and
a controller configured to:
calculate and display a drivable distance based on the information related to the remaining power amount of the battery,
obtain current state information of one or more factors related to the drivable distance among functions performed by the at least two device units, and
calculate an influence degree of each of the one or more factors related to the drivable distance based on the current state information of each of the one or more factors.

11. The drivable distance guiding system of claim 10, wherein the controller is configured to:
display the influence degrees of the one or more factors related to the drivable distance.

12. The drivable distance guiding system of claim 11, wherein the controller is configured to:
obtain information of at least two factors with highest power usage among the device units.

13. The drivable distance guiding system of claim 11, wherein the one or more factors related to the drivable distance comprises at least two of an average vehicle speed factor, an air conditioning factor related to power consumption information of an air conditioning device, a gradient factor related to a gradient of a road on which the electric vehicle is traveling, or a battery conditioning factor related to power consumption for battery conditioning.

14. The drivable distance guiding system of claim 13, wherein displaying the influence degrees of the one or more factors comprises:
setting a maximum value and a minimum value for each of the one or more factors, and
displaying current state information or a calculated influence degree for of each of the one or more factors, in a range between the maximum value and the minimum value.

15. The drivable distance guiding system of claim 13, wherein displaying the influence degrees of the one or more factors comprises:
displaying, based on a determination that a destination has been set, an initial influence degree of the one or more factors according to the current state information of each of the one or more factors, and
displaying a real-time influence degree of the one or more factors based on the current state information of each of the one or more factors, while the vehicle is traveling.

16. The drivable distance guiding system of claim 15, wherein the controller is configured to:
based on the real-time influence degree of a factor exceeding a specified reference compared to the initial influence degree of the factor, display an instruction to adjust the factor, adjust a function of the factor selected by a user, and display a drivable distance changed according to the adjusted factor.

17. The drivable distance guiding system of claim 16, wherein adjusting the function of the factor comprises:
based on an automatic control function being selected, adjusting each of the one or more factors to maximize the drivable distance.

18. The drivable distance guiding system of claim 17, wherein adjusting each of the one or more factors to maximize the drivable distance comprises:
limiting a maximum vehicle speed to adjust the average speed factor,
turning off the air conditioning device to adjust the air conditioning factor,
re-searching for a path including a road of a preset gradient to adjust the gradient factor, or
cancelling the battery conditioning function to adjust the battery conditioning factor.
